(19) United States
(12) Patent Application Publication
(10) Pub. No.: US 2017/0201736 A1
(43) Pub. Date: Jul. 13, 2017

(54) RANGE FINDER AND RANGE CORRECTION DEVICE CORRECTION PARAMETERS

(71) Applicants: DENSO CORPORATION, Kariya-city, Aichi-pref. (JP); TOYOTA SCHOOL FOUNDATION, Nagoya-shi, Aichi-ken (JP)

(72) Inventors: Kazuhisa Ishimaru, Nishio-city, Aichi-pref. (JP); Hossein Tehrani Niknejad, Kariya-city, Aichi-pref. (JP); Seiichi Mita, Nagoya-shi, Aichi-ken (JP); Qian Long, Nagoya-shi, Aichi-ken (JP)

(21) Appl. No.: 15/320,986

(22) PCT Filed: Jun. 17, 2015
(86) PCT No.: PCT/JP2015/067408

§ 371 Date: Dec. 21, 2016

(30) Foreign Application Priority Data
Jun. 23, 2014 (JP) 2014-128321

(51) Int. Cl. H04N 13/00; H04N 13/02; G01C 3/06

(52) U.S. Cl. CPC H04N 13/0022; G01C 3/06; H04N 13/0271; H04N 13/0239; H04N 2013/0081

(57) ABSTRACT

A range correction device includes an image acquiring unit, a collimating unit, a disparity calculating unit, and an updating unit. The image acquiring unit acquires stereo images formed of a plurality of simultaneously captured images. The collimating unit collimates the stereo images acquired by the image acquiring unit, using a correction parameter for correcting a vertical displacement between stereo images. The disparity calculating unit calculates a distribution of horizontal disparities between the stereo images from the stereo images collimated by the collimating unit. The updating unit calculates a distribution of vertical displacements between the stereo images on the basis of the stereo images and the distribution of horizontal disparities calculated by the disparity calculating unit and updates the correction parameter on the basis of the distribution of the calculated vertical displacements.

### CROSS-REFERENCE TO RELATED APPLICATION

This application is based on and claims the benefit of priority from earlier Japanese Patent Application No. 2014-128321 filed Jun. 23, 2014, the description of which is incorporated herein by reference.

### BACKGROUND OF THE INVENTION

Technical Field

The present disclosure relates to a ranging technique. More specifically, the present disclosure relates to a technique that acquires distance information from stereo images captured by a plurality of cameras, more specifically to a technique that corrects vertical displacement between stereo images.

Background Art

Three-dimensional measurement techniques, such as a stereo-matching method, are well known as techniques that acquire distance information from stereo images captured by a plurality of cameras. In the stereo-matching method, stereo matching is performed to search for regions corresponding to each other between the stereo images captured by a plurality of cameras. Then, a distance is calculated based on disparity between the images obtained by stereo matching.

To accurately achieve ranging by the stereo-matching method, it is desirable that there is no positional displacement in the stereo images other than disparity. However, actually, horizontal and vertical displacements are caused in the stereo images by the displacement between the mounting positions of the stereo cameras or by the shape of the camera lenses. When images of the outside area are captured through the windshield of a vehicle using stereo cameras installed in the interior of the vehicle, images captured by the stereo cameras are influenced by the refraction of the windshield. The postures of the stereo cameras or the distortions of the images have been calibrated by software/hardware methods to enhance ranging accuracy. However, the calibrated state is likely to be impaired with time being influenced by vibrations or the like.

JP-A-2003-83742 discloses a technique in which a reference target on a road is detected in the plane of a captured image, and the reference target is used as a basis to calculate spatially parallel approximate lines, followed by obtaining a vanishing point from the spatially parallel approximate lines. Then, based on the vanishing point, disparity including an error ascribed to horizontal displacement of the stereo cameras is corrected.

### CITATION LIST

### Patent Literature

Patent Literature 1: JP-A-2003-83742

The technique described in the above patent literature does not take account of correcting vertical displacement between stereo images. Vertical displacement between stereo images is likely to reduce the accuracy of stereo matching and increase errors in distance calculated based on stereo matching. To correct displacement between stereo images using the technique described in the above patent literature, it is necessary to use the recognition result of a specific target, such as a white line on the road, or to use a known calibration object.

### SUMMARY

The present disclosure provides a technique for correcting vertical displacement between stereo images without using the recognition result of a specific target or a known calibration object.

A range correction device according to the present disclosure includes an image acquiring unit, a collimating unit, a disparity calculating unit, and an updating unit. The image acquiring unit acquires stereo images formed of a plurality of images of a common region simultaneously captured by a plurality of cameras from different positions. The collimating unit collimates the stereo images acquired by the image acquiring unit, using a correction parameter for correcting a vertical displacement between stereo images. The disparity calculating unit calculates a distribution of horizontal disparities between the stereo images from the stereo images collimated by the collimating unit. The updating unit calculates a distribution of vertical displacements between the stereo images on the basis of the stereo images and the distribution of horizontal disparities calculated by the disparity calculating unit and updates the correction parameter on the basis of the distribution of the calculated vertical displacements.

According to the present disclosure, the correction parameters for correcting the vertical displacement between the stereo images are used to align the stereo images to thereby correct vertical displacement between the stereo images. After the correction, a horizontal disparity between the stereo images is calculated, thereby enhancing the accuracy of ranging, using a stereo-matching method. Based on newly acquired stereo images and horizontal disparities calculated from the stereo images, distribution of vertical displacements between the stereo images is calculated to thereby update the old correction parameters. With this configuration, the correction parameters can be updated as needed in conformity with the latest situation. Accordingly, the accuracy of ranging can be prevented from being impaired with time to thereby maintain and improve the ranging accuracy.

### BRIEF DESCRIPTION OF DRAWINGS

In the accompanying drawings:

FIG. 1 is a block diagram showing a configuration of a range finder;

FIG. 2 is a flowchart showing a procedure of a correction parameter calculating process;

FIG. 3A is a photograph showing an example of estimation of vertical displacement; and

FIG. 3B is photographs showing comparison between ranging with vertical displacement correction and ranging without vertical displacement correction.

### DETAILED DESCRIPTION OF THE PREFERRED EMBODIMENTS

With reference to the drawings, hereinafter will be described an embodiment of the present disclosure. It should be noted that the present disclosure should not be construed as being limited to the embodiment below, but can be implemented in various modes.

[Description of the Configuration of a Range Finder]

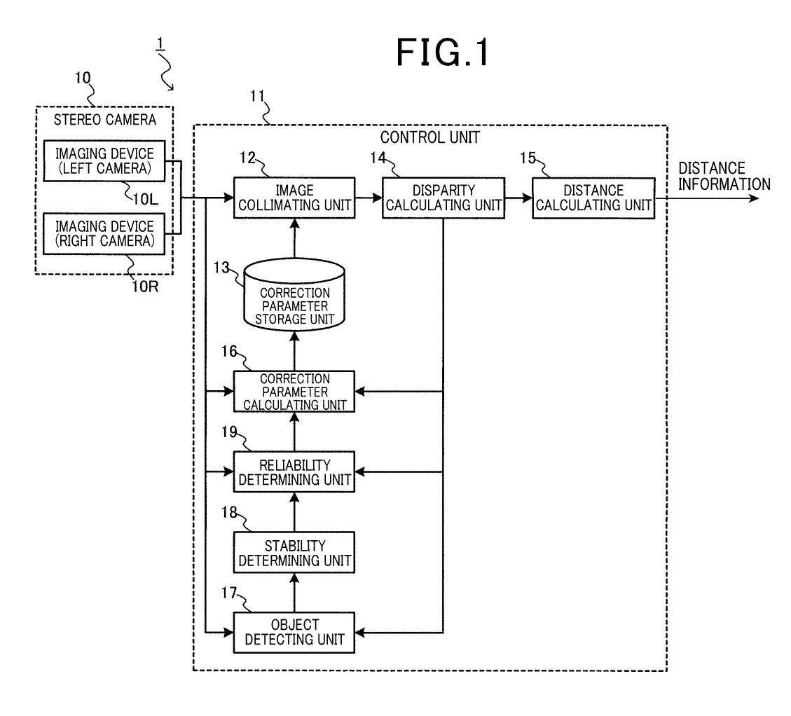

As shown in FIG. 1, a range finder 1 according to the present embodiment includes a stereo camera 10 and a control unit 11. The range finder 1 is installed in a vehicle (automobile or the like), for example, and embodied as a driver assistance system that assists the driver in driving the vehicle on the basis of the distance information on an object ahead of the vehicle. However, the embodiment of the present disclosure is not limited to devices installed in vehicles.

Similarly to known stereo cameras, the stereo camera 10 includes a pair of imaging devices which are a left camera 10L and a right camera 10R. The left and right cameras 10L and 10R are disposed being oriented to the traveling direction of the device-installed vehicle and being approximately parallel with each other (in a range of given installation accuracy) (parallel with each other and at the same level). The left and right cameras 10L and 10R each capture an image of a common region (region ahead of the device-installed vehicle) at the same timing, and input the image data representing stereo images formed of a pair of left and right images into the control unit 11.

The control unit 11 is mainly configured by a microcomputer including a CPU, ROM, RAM, and other components, not shown, to have control over the range finder 1. The control unit 11 implements various functions by allowing the CPU to execute programs recorded on the ROM and the like.

The control unit 11 includes, as a functional configuration, an image collimating unit 12, a correction parameter storage unit 13, a disparity calculating unit 14, a distance calculating unit 15, a correction parameter calculating unit 16, an object detecting unit 17, a stability determining unit 18, and a reliability determining unit 19.

The image collimating unit 12 corrects vertical displacement between stereo images inputted from the stereo camera 10 using correction parameters stored in the correction parameter storage unit 13, and collimates the stereo images to each other. Specifically, the image collimating unit 12 convert the coordinates of the entire pixels in terms of vertical direction on the basis of the correction parameters so that the heights of the corresponding image regions (e.g. pixels) between the stereo images horizontally coincide with each other, thereby correcting vertical displacement between the stereo images.

The correction parameters used for collimating the stereo images convert the coordinates of the entire pixels of the stereo images in terms of vertical direction, and are stored in the correction parameter storage unit 13, in the form of a table indicating the correction amount of each pixel or in the form of formulated functions.

Based on the stereo images collimated by the image collimating unit 12, the disparity calculating unit 14 calculates a horizontal disparity between the stereo images for each of image blocks, which are predetermined subsections of the entire images. Subsequently, a disparity map is prepared, in which the calculated horizontal disparities are correlated with the coordinates on the images. For calculating the horizontal disparity, techniques, such as stereo matching, can be used. Since stereo matching is a known technique, the details are omitted.

Based on the disparity map prepared by the disparity calculating unit 14, the distance calculating unit 15 calculates a distance to an object taken into the stereo images, prepares distance information indicating the calculated distance, and outputs the prepared information. As is well known, the distance to an object taken into the stereo images is indicated as a value that is inversely proportional to the horizontal disparity between the stereo images.

Based on the stereo images inputted from the stereo camera 10 and the horizontal disparities calculated by the disparity calculating unit 14 on the basis of the stereo images, the correction parameter calculating unit 16 calculates a displacement in the vertical direction between the stereo images (hereinafter referred to as “vertical displacement”), and updates the old correction parameters on the basis of the calculated result.

Specifically, the correction parameter calculating unit 16 calculates a vertical displacement between the stereo images using an algorithm for optimally obtaining an optical flow between the stereo images and also using the calculated result of the horizontal disparities between the stereo images. Generally, a process of obtaining an optical flow of images is performed with respect to sequential images with time. In this regard, the present disclosure uses, as characteristics of the present disclosure, a process of obtaining an optical flow with respect to the left and right images forming the stereo images. The left and right images forming the stereo images correspond to observation at the same moment in time. Therefore, if the horizontal disparity of the left and right images is already available, a vertical displacement between the stereo images can be estimated through a procedure for obtaining an optical flow around the correlated pixels. The detailed procedure for obtaining the optical flow between stereo images will be described later.

Based on the stereo images inputted from the stereo camera 10 and the horizontal disparity calculated by the disparity calculating unit 14 on the basis of the stereo images, the object detecting unit 17 detects a detection target taken into the images (e.g. a white line on the road, or the like) using a known image recognition method. The stability determining unit 18 determines the stability of the detection state of the object detecting unit 17. Specifically, the stability determining unit 18 determines if there is an occurrence of unstable detection, such as a hunting phenomenon, in which detection and non-detection are repeated.

Based on the status of the stereo images, the status of horizontal disparity calculation conducted by the disparity calculating unit 14, and the determination on the stability of object detection conducted by the stability determining unit 18, the reliability determining unit 19 determines the reliability of the vertical displacement between the stereo images calculated by the correction parameter calculating unit 16. Depending on the reliability determination, the correction parameter calculating unit 16 restricts calculation of the vertical displacement between the stereo images such that restricted calculation is for the entire images, or for a part of the images.

[Description of a Correction Parameter Calculating Process]

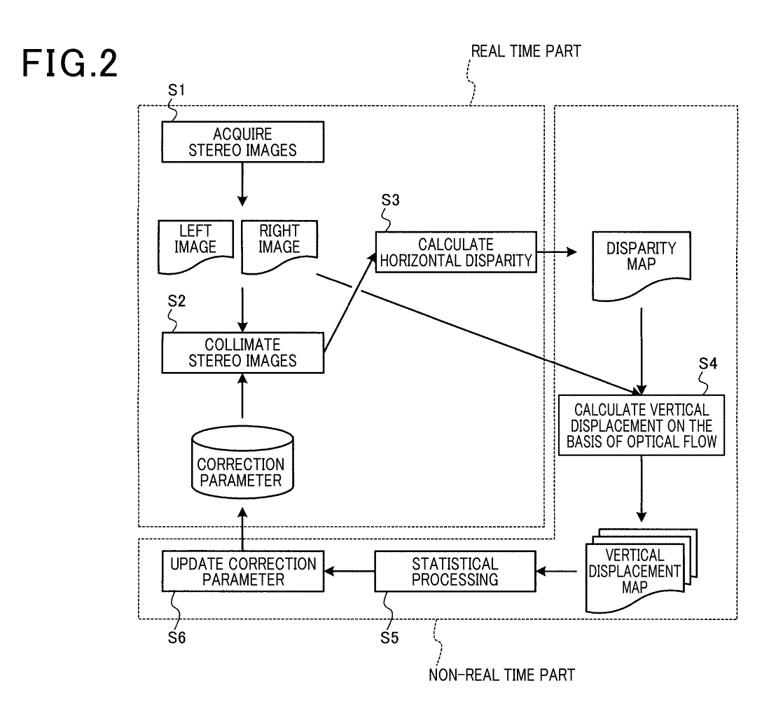

Referring to a flowchart of FIG. 2, a correction parameter calculating process performed by the control unit 11 will be described.

First, in step S1, the control unit 11 acquires image data representing a left image captured by the left camera 10L and image data representing a right image captured by the right camera 10R. In the subsequent step S2, the control unit 11 corrects the vertical displacement between the stereo images formed of the left and right images acquired in step S1 using the currently available correction parameters stored in the correction parameter storage unit 13, and collimates the stereo images. Step S2 is implemented as a function of the image collimating unit 12 of the control unit 11.

In the subsequent step S3, the control unit 11 calculates a horizontal disparity between the stereo images collimated in step S2, and prepares a disparity map, in which calculated horizontal disparities are correlated with the coordinates on the images. Step S3 is implemented as a function of the disparity calculating unit 14 of the control unit 11.

In step S4, based on the stereo images acquired in step S1 and the disparity map prepared based on the stereo images in step S3, the control unit 11 calculates a vertical displacement between the stereo images. Herein, the vertical displacement between the stereo images is calculated by a process of optimally obtaining an optical flow between the stereo images.

In estimating an optical flow, the pixels corresponding to each other between a reference image, which is one of the stereo images, and a comparison image, which is the other of the stereo images, are taken to have (substantially) an equivalent luminance. Then, the control unit 11 searches for the regions highly analogous to each other in the luminance of the pixels between the reference image and the comparison image to calculate a coordinate displacement between the pixels corresponding to each other. Herein, of the vectors representing coordinate displacements between the corresponding pixels, one from which the components of horizontal disparity indicated in the disparity map have been removed is taken to be a vertical displacement between the stereo images at the positions of the pixels in question. The control unit 11 carries out pixel-basis calculation of vertical displacements for the entire images, and prepares a vertical displacement map in which the calculated vertical displacements are correlated with the coordinates on the images.

The following description specifically sets forth a method of calculating a vertical displacement between the stereo images. Herein, the luminance at coordinates (x, y) on the left one of the stereo images is indicated by I₀(x, y), and the luminance at coordinates (x, y) on the right one is indicated by I₁(x, y), where x is a horizontal coordinate on the images, and y is a vertical coordinate on the images.

Assuming a state where no vertical displacement is present at all between the stereo images, a relationship expressed by the following Formula (1) is established regarding the luminance of the left and right images.

[Math. 1]

I₀(x,y)≈I₁(x−u,y) Formula (1)

In Formula (1), u is a value (the number of pixels) of a horizontal disparity indicated in the disparity map.

Actually, between the pixels corresponding to each other between the left and right images, there is a vertical displacement due to distortion or the like of the stereo camera 10, in addition to a horizontal disparity. In this regard, when the value (the number of pixels) of the vertical displacement between the left image coordinates (x, y) and the corresponding right image pixels is defined to be v, the luminance of the left and right images is expressed by the following Formula (2).

[Math. 2]

I₀(x,y)≈I₁(x−u,y+v) Formula (2)

Accordingly, the vertical displacement v is calculated on a pixel basis, on the basis of a relational expression of optical flow. First, for the pixels of the right image, correlation between luminance and coordinates is substituted as expressed by the following Formula (3) to cancel the horizontal disparity u between the left and right images, and then the vertical displacement v is obtained by the relational expression of optical flow expressed by the following Formula (4).

$$\begin{matrix}[ Math . 3 ] & \\ {\overline{I}}_{1} ( x , y ) = {I}_{1} ( x - u , y ) & Formula ( 3 ) \\ [ Math . 4 ] & \\ \hat{v} = {argmin}_{v} {\sum }_{all pixels} ( {\vert {\overline{I}}_{1} ( x , y + v ) - {I}_{0} ( x , y ) \vert}^{2} + λ {\vert ∇ v \vert}^{2} ) & Formula ( 4 )\end{matrix}$$

where λ is a parameter for adjusting the smoothness of the solution space (for reducing variation of v and stabilizing the solution), and ∇v is a variation of v.

Formula (4) is a relational expression for calculating the parameter v that minimizes an error function which is calculated from a sum total of squares of a difference between the luminance of a pixel vertically shifted by v pixel from the corresponding point (x, y) on the right image and the luminance of the pixel at the corresponding point (x, y) on the left image (Lucas-Kanade method). Formula (4) is a convex optimization problem, which is known to be based on that “a minimum value, if present, is a global minimum value”. When Formula (4) is Taylor expanded, the following Formula (5) is obtained.

$$\begin{matrix} [ Math . 5 ] & \\ \hat{v} = {argmin}_{v} {\sum }_{all pixels} ( {\vert {\overline{I}}_{1} ( x , y + v ) - {\overline{I}}_{1}^{y} ( x , y ) - {I}_{0} ( x , y ) \vert}^{2} + λ {\vert ∇ v \vert}^{2} ) & Formula ( 5 )\end{matrix}$$

where Ī₁^{y} is a differential image of the right image in the vertical direction, and v₀ is an initial value of v.

When Formula (5) is modified, the following Formula (6) is obtained.

$$\begin{matrix} [ Math . 6 ] & \\ \hat{v} = {argmin}_{v} {\sum }_{all pixels} ( \begin{matrix}{\vert {\overline{I}}_{1} ( x , y + {v}_{0} ) - {\overline{I}}_{1}^{y} ( v - {v}_{0} ) - {I}_{0} ( x , y ) \vert}^{2} + \\ λ {\vert {v}_{x} \vert}^{2} + λ {\vert ∇ {v}_{y} \vert}^{2}\end{matrix} ) & Formula ( 6 )\end{matrix}$$

where vₓ is a deviation between v and v₀ in the x direction, and v_{y} is a deviation between v and v₀ in the y direction.

When Formula (6) is converted into a matrix form, the following Formula (7) is obtained.

[Math. 7]

\hat{v}=min|C₁v+b|²+λ|C₂v|²+λ|C₃v|² Formula(7)

where C₁ is a matrix expressing a differential image of the right image in the vertical direction, C₂ is a matrix expressing a difference between v and v₀ in the x direction, C₃ is a matrix expressing a difference between v and v₀ in the y direction, and b is Ī₁(x,y+v₀)+Ī₁^{y}v₀−I₀(x,y).

The minimization of Formula (7) means that the partial derivative of v becomes 0. The vertical displacement v can be calculated by solving the following Formula (8).

$$\begin{matrix}[ Math . 8 ] & \\ \frac{\partial ( {\vert {C}_{1} v + b \vert}^{2} + λ {\vert {C}_{2} v \vert}^{2} + λ {\vert {C}_{3} v \vert}^{2} )}{\partial v} = 0 \\ ( {C}_{1}^{T} {C}_{1} + λ {C}_{2}^{T} {C}_{2} + λ {C}_{3}^{T} {C}_{3} ) v = - {C}_{1}^{T} b & Formula ( 8 )\end{matrix}$$

Formula (8) can be solved by a least squares method. To solve Formula (8), iterative computation is required to be conducted several times. In a first computation, the initial values v₀ of v are all taken as being set to zero. From the subsequent computations, the previous value of v estimated in the past is used as v₀. The calculation of optical flow in step S4 is applied to a plurality of pairs of stereo images captured at different time points, and the calculated results are averaged, thereby estimating a vertical displacement v in a robust manner.

Returning to the flowchart of FIG. 2, in step S4, the control unit 11 stores several vertical displacement maps calculated from a plurality of pairs of stereo images. In step S5, the control unit 11 conducts statistical processing, such as averaging, to a plurality of accumulated vertical displacement maps. In step S6, the control unit 11 prepares correction parameters on the basis of the vertical displacement maps for which statistical processing has been conducted in step S5, and records the correction parameters in the correction parameter storage unit 13 to update the old correction parameters. Steps S4 to S6 are implemented as a function of the correction parameter calculating unit 16 of the control unit 11.

Of the series of steps S1 to S6 described above, steps S1 to S3 correspond to a real-time processing part required to be completed within a predetermined time period to reflect the calculation results of horizontal disparity to distance calculation or object detection. On the other hand, steps S4 to S6 correspond to a non-real time processing part not requiring real time processing because the vertical displacement maps related to a plurality of pairs of stereo images are accumulated and statistically processed to prepare correction parameters.

[Calculation Examples]

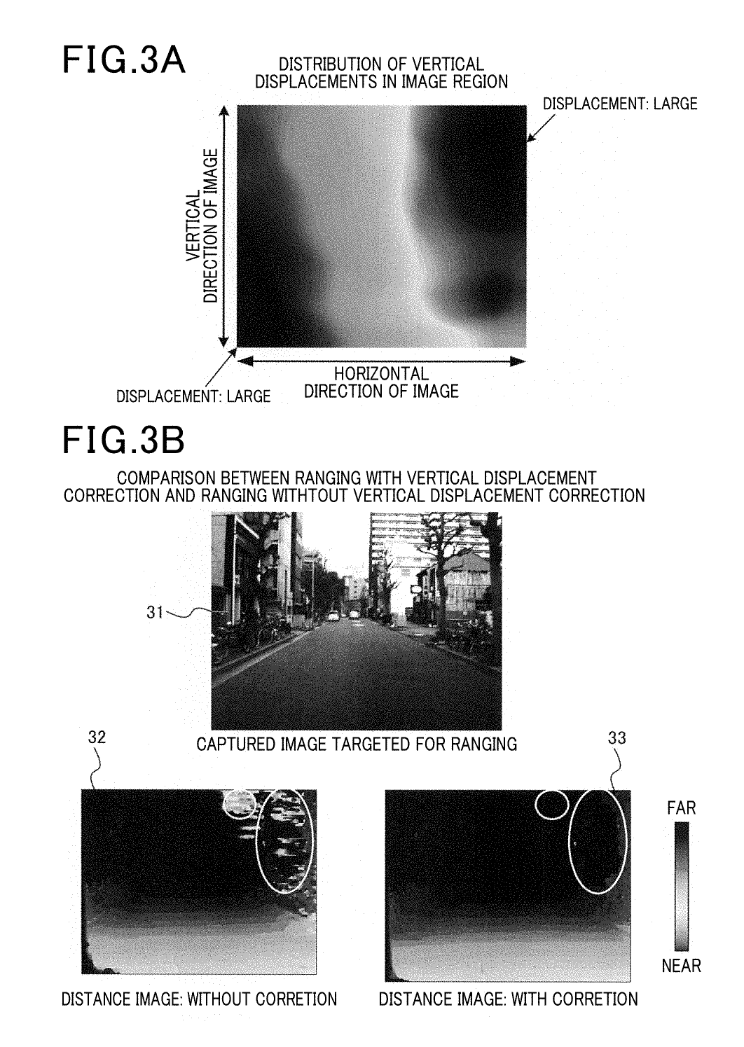

FIG. 3A is an image of distribution of vertical displacements between stereo images obtained by statistically processing vertical displacement maps calculated from 300 frames of stereo images. The image expresses the degree of vertical displacement with a gray scale. Darker gray means greater amount of vertical displacement. In the example of FIG. 3A, the vertical displacement is large in the upper-right and lower-left portions of the image, and is particularly noticeable in the upper-right portion.

FIG. 3B are photographs showing an image 31 of a ranging target captured by the stereo camera 10 having the vertical displacements shown in FIG. 3A, a distance image 32 of distance calculation conducted for the image 31 without correcting the vertical displacements, and a distance image 33 of distance calculation conducted for the image 31 after correcting the vertical displacements.

As shown in FIG. 3B, in the distance image 32 without correcting the vertical displacements, unnatural near-distance objects appear in the encircled portions in the upper-right of the image. The unnatural near-distant objects do not appear in the image 31 as a target of ranging. In contrast, in the distance image 33 that has been corrected based on the results of calculation of the vertical displacements, the unnatural near-distant objects do not appear, providing a ranging result approximately matching the landscape shown in the image 31 as a target of ranging.

[Schemes for Further Improving Reliability and Accuracy of Correction Parameters]

The reliability determining unit 19 determines specific conditions under which accuracy is expected to be reduced in calculating vertical displacement. Under the conditions, the correction parameter calculating unit 16 limits calculation of vertical displacement to enhance the accuracy and reliability of the correction parameters. In this case, objects that are targeted for limiting calculation of vertical displacement may be pixels satisfying specific conditions, or peripheral regions of the pixels, or the entire images. Specifically, calculation of vertical displacement can be limited under conditions (1) to (5) below to achieve high reliability and accuracy of correction parameters.

(1) In the stereo images inputted from the stereo camera 10, when clipped whites (state where gradation of bright portion is lost to cause the entire region to be whitened) or crushed shadows (state where gradation of dark portions is lost to cause the entire region to be darken) occur, the reliability determining unit 19 determines that the reliability is low in the vertical displacement obtained from the portions in question of the images. In this case, the pixels with clipped whites and crushed shadows, and the regions around these pixels can be excluded from vertical displacement calculation.

(2) In stereo matching conducted by the disparity calculating unit 14, when the matching cost (degree of difference) between the left and right images is high, the reliability determining unit 19 determines that the reliability is low in the vertical displacement obtained from the portions in question of the images. In this case, the pixels concerned and the regions around the pixels are excluded from vertical displacement calculation.

(3) When a wiper (not shown) provided to the windshield of a vehicle is operating, being present in the field of view of the stereo camera 10, the reliability determining unit 19 determines that the reliability is low in the vertical displacement obtained from the stereo images.

(4) In the left and right images that have been subjected to one-to-one correspondence conversion by geometric transformation, when halation or the like occurs in one of the images causing the images not to be analogous, the reliability determining unit 19 determines that the reliability is low in the vertical displacement obtained from the stereo images.

(5) In the stability determining unit 18 that determines the stability in the status of detection conducted by the object detecting unit 17, when a phenomenon (hunting) or the like of repeating detection and non-detection is detected, the reliability determining unit 19 determines that the reliability is low in the vertical displacement obtained from the stereo images.

### ADVANTAGEOUS EFFECTS

According to the range finder 1 of the embodiment, the following advantageous effects are obtained.

The image collimating unit 12 collimates the stereo images using the correction parameters. Thus, the vertical displacement between the stereo images can be corrected. After the correction, the disparity calculating unit 14 calculates a horizontal disparity between the stereo images. Thus, the accuracy of ranging conducted by the distance calculating unit 15 can be enhanced. The correction parameter calculating unit 16 calculates a vertical displacement between the stereo images on the basis of newly acquired stereo images and the horizontal disparity calculated from the stereo images, thereby updating the old correction parameters. With this configuration, the correction parameters can be updated as needed in conformity with the latest situations. Accordingly, the accuracy of ranging can be prevented from being impaired with time to thereby maintain and improve the ranging accuracy.

### REFERENCE SIGNS LIST

1 . . . Range finder
10 . . . Stereo camera
10L . . . Imaging device (left camera)
10R . . . Imaging device (right camera)
11 . . . Control unit
12 . . . Image collimating unit
13 . . . Correction parameter storage unit
14 . . . Disparity calculating unit
15 . . . Distance calculating unit
16 . . . Correction parameter calculating unit
17 . . . Object detecting unit
18 . . . Stability determining unit
19 . . . Reliability determining unit

1. A range correction device comprising:
an image acquiring unit that acquires stereo images formed of a plurality of images of a common region simultaneously captured by a plurality of cameras from different positions;
a collimating unit that collimates the stereo images acquired by the image acquiring unit, using a correction parameter for correcting a vertical displacement between the stereo images;
a disparity calculating unit that calculates distribution of horizontal disparities between the stereo images from the stereo images collimated by the collimating unit; and
an updating unit that calculates distribution of vertical displacements between the stereo images on the basis of the stereo images and the distribution of horizontal disparities calculated by the disparity calculating unit and updates the correction parameter on the basis of the distribution of the calculated vertical displacements.

2. The range correction device according to claim 1, wherein
the updating unit prepares distribution of vertical displacements between the stereo images by calculating a vertical component of optical flow between the stereo images on the basis of the stereo images and the distribution of horizontal disparities calculated by the disparity calculating unit.

3. The range correction device according to claim 1, wherein
the updating unit calculates several distributions of vertical displacements between the stereo images, for each of the stereo images captured several times at different time points and updates the correction parameter on the basis of a result of statistical processing of calculation results of the stereo images captured several times.

4. The range correction device according to claim 1, wherein
the range correction device comprises a reliability determining unit that determines reliability of the calculation result of the updating unit on the basis of at least any of a status of stereo images acquired by the image acquiring unit, a status of calculation of a horizontal disparity between the stereo images conducted by the disparity calculating unit, or an operating status of a specific machine influencing a field of view of the camera; and
the updating unit limits calculation of distribution of vertical displacements between the stereo images according to a determination result of the reliability determining unit.

5. A range finder comprising:
an image acquiring unit that acquires stereo images in which an object is imaged, the stereo images being formed of a plurality of images of a common region simultaneously captured by a plurality of cameras from different positions;
a collimating unit that collimates the stereo images acquired by the image acquiring unit, using a correction parameter for correcting a vertical displacement between stereo images;
a disparity calculating unit that calculates distribution of horizontal disparities between the stereo images from the stereo images collimated by the collimating unit;
an updating unit that calculates distribution of vertical displacements between the stereo images on the basis of the stereo images and the distribution of horizontal disparities calculated by the disparity calculating unit and updates the correction parameter on the basis of the distribution of the calculated vertical displacements; and
a distance calculating unit that calculates a distance to the object on the basis of the distribution of horizontal disparities calculated by the disparity calculating unit, and prepares and outputs distance information indicating the calculated distance.

6. The range finder according to claim 5, wherein
the updating unit prepares distribution of vertical displacements between the stereo images by calculating a vertical component of optical flow between the stereo images on the basis of the stereo images and the distribution of horizontal disparities calculated by the disparity calculating unit.

7. The range finder according to claim 5, wherein
the updating unit calculates a plurality of distributions of vertical displacements between the stereo images for the stereo images captured at a plurality of times at different timings and updates the correction parameter based on a result in which a plurality of calculated results is subjected to statistical processing.

8. The range finder according to claim 5, wherein
the range finder comprises a reliability determining unit that determines reliability of the calculation result of the updating unit on the basis of at least any of a status of stereo images acquired by the image acquiring unit, a status of calculation of a horizontal disparity between the stereo images conducted by the disparity calculating unit, or an operating status of a specific machine influencing a field of view of the camera; and
the updating unit limits calculation of distribution of vertical displacements between the stereo images according to a determination result of the reliability determining unit.
